(19) United States
(12) Patent Application Publication
(10) Pub. No.: US 2015/0124552 A1
(43) Pub. Date: May 7, 2015

(54) SYSTEM AND METHOD FOR MIXING A GAS AND A LIQUID

(71) Applicants: Yang Shi, Zhong Guan Cun (CN); Hongxiao Shao, Thousand Oaks, CA (US)

(72) Inventors: Yang Shi, Zhong Guan Cun (CN); Hongxiao Shao, Thousand Oaks, CA (US)

(21) Appl. No.: 14/531,920

(22) Filed: Nov. 3, 2014

Related U.S. Application Data
(60) Provisional application No. 61/899,787, filed on Nov. 4, 2013.

(51) Int. Cl. B01F 3/04; B01F 11/02

(52) U.S. Cl. CPC B01F 3/04978; B01F 11/0258; B01F 11/0208
USPC 366/124

(57) ABSTRACT

A system and method for mixing a gas and a liquid includes, receiving a liquid at a liquid inlet of a convergent nozzle and ejecting the liquid at a predetermined output velocity from a liquid outlet of the convergent nozzle into a mixing chamber, the mixing chamber comprising a cantilevered reed positioned within the mixing chamber. The ejection of the liquid from the liquid outlet causes the cantilevered reed to vibrate at an intrinsic frequency. The vibration of the cantilevered reed induces resonance between the liquid and the cantilevered reed and the resonance results in an ultrasound wave within the liquid. Upon the introduction of a gas into the liquid within the mixing chamber, the mixing of the gas into the liquid is effected by the ultrasound wave generated by the cantilevered reed.

### TECHNICAL FIELD

The present application relates generally to a system and method for mixing a gas and a liquid and more particularly to a system and method for ultrasonic homogenization of an inert gas in a liquid.

### BACKGROUND

Various methods are known in the art for mixing fluids, including liquid-liquid mixtures and liquid-gas mixtures. Both electrical and fluid dynamic systems have been investigated for generating ultrasound waves that are capable of inducing the mixing of liquids in liquids and gases in liquids.

Electrically generated ultrasound waves have been shown to be effective in homogenizing water clusters, however these systems are often composed of external electrical equipment that is expensive and inefficient, requiring a large amount of expended energy to generate a desired mixing result. Additionally, these systems have been shown to be capable of mixing only small quantities of liquids and are not effective in mixing a gas and a liquid. Accordingly, the electrical generation of ultrasound waves for the mixing of liquids and gases is not suited for industrial applications.

Fluid dynamic based emulsifiers are also known in the art for liquid-liquid mixing. While fluid dynamic based mixers overcome some of the deficiencies of the electrically generated ultrasound wave mixers, the fluid dynamic based systems currently known in the art are capable of generating only relatively low-power ultrasound waves. The low-power ultrasound waves generated by the fluid dynamic based mixing systems known in the art are ineffective in generating gas-liquid mixtures and result in undesirable, non-uniform, liquid-liquid mixtures.

Accordingly, there is a need in the art for an improved fluid dynamic based ultrasound mixing system for mixing a liquid and a gas that is efficient, economical and capable of generating a homogenous liquid-gas mixture.

### SUMMARY

An improved fluid dynamic based ultrasound mixing system and method for mixing a liquid and a gas that is efficient, economical and capable of generating a homogenous liquid-gas mixture is provided. In particular, a fluid dynamic based ultrasonic jet homogenizer for inert gas and liquid mixing is described.

The system includes a convergent nozzle having a liquid inlet for receiving a liquid into a fluid channel of the convergent nozzle and a liquid outlet for ejecting the liquid from the fluid channel of the convergent nozzle. Upon the introduction of a liquid into the fluid channel at the liquid inlet of the convergent nozzle at a predetermined inlet velocity, the dimensions of the liquid inlet and liquid outlet of the convergent nozzle result in the liquid being ejected from the liquid outlet at a predetermined outlet velocity. A mixing chamber is positioned to receive the liquid ejected from the liquid outlet of the convergent nozzle. At least one gas introducer is positioned within the mixing chamber and located proximate to the liquid outlet of the convergent nozzle, the at least one gas introducer is configured to introduce a gas into the liquid being ejected from the convergent nozzle. A cantilevered reed is positioned within the mixing chamber. The cantilevered reed is configured to vibrate at an intrinsic frequency when subjected to the liquid ejected from the liquid outlet at the predetermined output velocity. The vibration of the cantilevered reed induces resonance between the liquid and the cantilevered reed which produces an ultrasound wave within the liquid. The ultrasound wave generated in the liquid as a result of the resonant vibration of the cantilevered reed is effective in mixing the gas introduced by the gas introducer and the liquid ejected from the convergent nozzle.

In a particular embodiment, there are two gas introducers positioned on opposite sides of the cantilevered reed.

In an additional embodiment, the convergent nozzle is secured within a housing and the cantilevered reed is secured within a reed bracket and both the housing and the reed bracket are positioned within a pipe.

A method of mixing a gas and a liquid includes, receiving a liquid at a liquid inlet of a convergent nozzle and ejecting the liquid at a predetermined output velocity from a liquid outlet of the convergent nozzle into a mixing chamber, the mixing chamber comprising a cantilevered reed positioned within the mixing chamber. The ejection of the liquid from the liquid outlet causes the cantilevered reed to vibrate at an intrinsic frequency. The vibration of the cantilevered reed induces resonance between the liquid and the cantilevered reed and the resonance results in an ultrasound wave within the liquid. Upon the introduction of a gas into the liquid within the mixing chamber, wherein the gas is introduced proximate to the liquid outlet of the convergent nozzle, the mixing of the gas into the liquid is effected by the ultrasound wave generated by the cantilevered reed.

In accordance with the present invention, an improved fluid dynamic based ultrasound mixing system and method for mixing a liquid and a gas that is efficient, economical and capable of generating a homogenous liquid-gas mixture is provided.

### BRIEF DESCRIPTION OF THE DRAWINGS

FIG. 1 is a diagrammatic view of a horizontal cross-section of an ultrasonic liquid-gas mixing system in accordance with an embodiment of the present invention.

FIG. 2 is a diagrammatic view of a vertical cross-section of an ultrasonic liquid-gas mixing system in accordance with an embodiment of the present invention.

### DETAILED DESCRIPTION

Those of ordinary skill in the art will realize that the following detailed description of embodiments in this specification is illustrative only, and is not intended to be in any way limiting. Other embodiments will readily suggest themselves to such skilled persons having the benefit of this disclosure. It will be apparent to one skilled in the art that these specific details may not be required to practice the embodiments. In the following description of the embodiments, substantially the same parts are denoted by the same reference numerals.

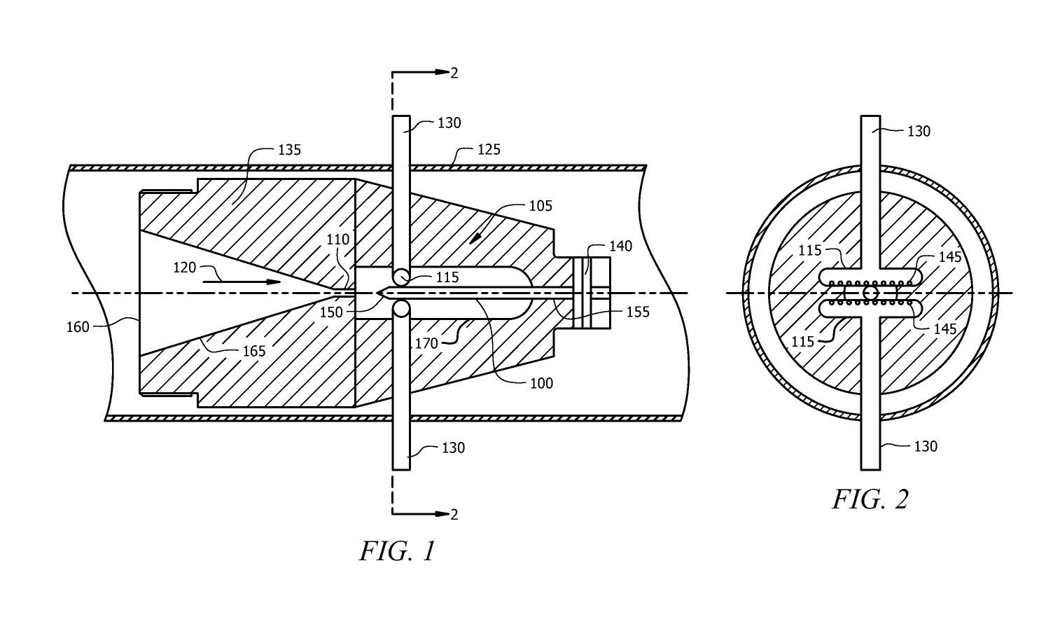

FIG. 1 illustrates a horizontal cross-section of the liquid-gas mixing system in accordance with an embodiment of the present invention. With reference to FIG. 1, in accordance with the present invention, a system for mixing a gas and a liquid includes a convergent nozzle 165 having a liquid inlet 160 for receiving a liquid into a fluid channel 120 of the convergent nozzle 165 and a liquid outlet 110 for ejecting the liquid from the fluid channel 120 of the convergent nozzle 165. Upon the introduction of a liquid into the fluid channel 120 at the liquid inlet 110 of the convergent nozzle 165 at a predetermined inlet velocity, the dimensions of the liquid inlet 160 and liquid outlet 110 of the convergent nozzle 165 result in the liquid being ejected from the liquid outlet 110 at a predetermined outlet velocity. A mixing chamber 170 is positioned to receive the liquid ejected from the liquid outlet 110 of the convergent nozzle 165. At least one gas introducer 130 is positioned within the mixing chamber 170 and located proximate to the liquid outlet 110 of the convergent nozzle 165, the at least one gas introducer 130 is configured to introduce a gas into the liquid being ejected from the convergent nozzle 165. A cantilevered reed 100 is positioned within the mixing chamber 165. The cantilevered reed 100 is configured to vibrate at an intrinsic frequency when subjected to the liquid ejected from the liquid outlet 110 at the predetermined output velocity. The vibration of the cantilevered reed 100 induces resonance between the liquid and the cantilevered reed 100 which produces an ultrasound wave within the liquid. The ultrasound wave generated in the liquid as a result of the resonant vibration of the cantilevered reed 110 is effective in mixing the gas introduced by the gas introducer 130 and the liquid ejected from the convergent nozzle 165.

In physics, resonance is the tendency of a system, or particular set of components of a system, to vibrate or oscillate at greater amplitudes at some frequencies than at other frequencies. The frequencies at which the amplitude of the vibrations are at a relative maximum are commonly referred to as the resonant or resonance frequencies of the system. It is known that at the resonant frequency, a relatively small driving force can result in large oscillations of the system components. In the present invention, an ultrasound or ultrasonic wave, having a frequency greater than about 20 kHz, is induced within the liquid when the cantilevered reed 100, having known resonant frequencies, is subjected to a jet of liquid ejected from the convergent nozzle 165 at a predetermined output velocity that is effective in initiating resonance of the cantilevered reed 100. The ultrasound wave that is induced within the liquid facilitates the mixing of the liquid with the gas introduced into the mixing chamber 170 from one or more gas introducers 130. The liquid ejected from the convergent nozzle 165 causes the cantilevered reed 100 to vibrate, and when the liquid and the cantilevered reed 100 reach resonance, a high-power ultrasound wave results. The power level of the ultrasound wave can reach approximately 170-180 dB, which is sufficient to generate cavitation effects in the liquid. Cavitation of the liquid results in voids or bubbles formed within the liquid.

The system and method of the present invention improves the liquid-gas homogenization process. Under the influence of a high power ultrasound wave induced by the cantilevered reed 100 and the ejected liquid, the molecules in the liquid and gas are induced to move at a very high speed, resulting in a sharp temperature rise which increases the internal pressure of the gas bubbles inside the liquid. When the pressure becomes high enough, the bubbles break into smaller bubbles. The generation of these smaller bubbles increases the interface areas of the gas and the liquid, thus enhancing the liquid-gas mixing and improving the liquid-gas homogenization. In the homogenized liquid-gas mixture, the gas is microscopically dispersed throughout the liquid.

Nozzles are known to be used to control the direction and characteristics of a flow of fluid through the nozzle. In particular, the design of a nozzle can be used to increase the velocity of a fluid flow as it exits the nozzle. The convergent nozzle 165 of the present invention is characterized by a narrowing of the fluid channel 120 from a relatively large dimension at the liquid inlet 160 to a relatively small dimension at the liquid outlet 110. The narrowing of the convergent nozzle 165, in the direction of the fluid flow, while the amount of fluid ejected is maintained, results in an increase in the velocity of the liquid between the liquid inlet 160 and the liquid outlet 110 of the convergent nozzle 165.

In a particular embodiment, the liquid is introduced into the liquid inlet 160 of the convergent nozzle 165 by a liquid pump (not shown). The liquid pump introduces the liquid into the liquid inlet 160 at a predetermined input velocity and the liquid outlet 110 ejects the liquid from the convergent nozzle 165 at a predetermined output velocity that is determined, in part, by the predetermined input velocity of the liquid and the dimensions of the convergent nozzle 165. In a specific embodiment, the liquid outlet 110 of the convergent nozzle 165 is a substantially narrow slit opening. Under high pressure, the narrow slit opening of the convergent nozzle 165 results in a high velocity jet of liquid in the shape of a sheet being ejected from the liquid outlet 110. The exemplary narrow slit opening shape of the liquid outlet 110 of the convergent nozzle 165 is not meant to be limiting and various other shapes of the liquid outlet 110 are considered within the scope of the present invention.

The liquid-gas mixing system further includes a housing 135 to secure the convergent nozzle 165 and a reed bracket 105 to secure the cantilevered reed 100 and to establish the mixing chamber 170. The housing 135 and the reed bracket 105 are positioned such that the liquid outlet 110 of the convergent nozzle 165 is adjacent to the mixing chamber 170 established by the reed bracket 105. To contain the flow of liquid through the system, the housing 135 and the reed bracket 105 are positioned within a pipe 125 and the gas introducers 130 are inserted through the pipe 125 and the reed bracket 105 to introduce the gas into the liquid within the mixing chamber 170.

The cantilevered reed 100 includes a tapered reed tip 150 and a substantially planar body portion 155. The substantially planar body portion 155 of the cantilevered reed 100 is secured to the reed bracket 105, at an end distal from the liquid outlet 110, by a securing element 140, such as a bolt. When secured in the reed bracket 105, the tapered reed tip 150 of the cantilevered reed 100 is positioned at the liquid outlet 110 of the convergent nozzle 165. The cantilevered reed 100 is positioned substantially in-line with the liquid being ejected from the liquid outlet 110. The shape and dimensions of the cantilevered reed 100 are not meant to be limiting and various other shapes and dimensions are within the scope of the present invention.

FIG. 2 illustrates a vertical cross-section of the liquid-gas mixing system at the point of the introduction of gas into the mixing chamber 170. As shown with reference to FIG. 2, at least one gas introducer 130 is provided to introduce gas into the mixing chamber 170 to be mixed with the liquid ejected from the convergent nozzle 165. The gas introducer 130 includes gas inlet pipe and for receiving the gas to be mixed with the liquid and a gas outlet pipe 115 for ejecting the gas into the mixing chamber 170. The gas outlet pipe 115 may be a substantially short pipe, closed at both ends and comprising a plurality of spaced apart apertures 145. To effectively introduce gas into the liquid, the gas outlet pipe 115 is positioned substantially perpendicular to a longitudinal axis of the cantilevered reed 100 and the gas outlet pipe 115 includes a plurality of spaced apart apertures 145 for ejecting the gas into the mixing chamber 170. As shown in FIG. 2, in a particular embodiment, there are two gas introducers 130. A first gas introducer 130 includes a first gas inlet pipe for receiving the gas to be mixed with the liquid and a first outlet pipe 115 for ejecting the gas into the mixing chamber, wherein the first outlet pipe is positioned on a first side of the cantilevered reed 100 and substantially perpendicular to a longitudinal axis of the cantilevered reed and the first gas outlet pipe 115 comprising a plurality of spaced apart apertures for ejecting the gas into the mixing chamber 170. Additionally, a second gas introducer 130 includes a second gas inlet pipe for receiving the gas to be mixed with the liquid and a second outlet pipe 115 for ejecting the gas into the mixing chamber, wherein the second outlet pipe is positioned on a second side of the cantilevered reed 100 and substantially perpendicular to a longitudinal axis of the cantilevered reed and the second gas outlet pipe comprising a plurality of spaced apart apertures for ejecting the gas into the mixing chamber 170.

The system and method of the present invention provide a high level of homogenization between the gas and the liquid. When the liquid is ejected at the liquid outlet 110 of the convergent nozzle 165, proximate to the gas introducers 130, a negative pressure results in the surrounding region as a result of the increased velocity of the liquid at the liquid outlet 110. The gas from the gas introducers 130 is effectively pulled into the liquid under this reduced pressure, slowly and uniformly. When subjected to a high ultrasound wave, the gas and liquid interface area is increased as a result of cavitation of the liquid, thereby speeding-up the mixing process and enhancing the uniformity of the homogenization of the liquid and gas.

The components of the liquid-gas mixing system of the present invention may be composed of stainless steel, cast-iron, brass or various other element or alloys commonly known to be used in the field of fluid dynamics.

The liquid-gas mixing system of the present invention is scalable and the physical dimensions of the system may range from a few centimeters to greater than forty centimeters, depending upon the specific application of the system.

A method of mixing a gas and a liquid in accordance with the present invention includes, receiving a liquid at a liquid inlet of a convergent nozzle and ejecting the liquid at a predetermined output velocity from a liquid outlet of the convergent nozzle into a mixing chamber, the mixing chamber comprising a cantilevered reed positioned within the mixing chamber. The ejection of the liquid from the liquid outlet causes the cantilevered reed to vibrate at an intrinsic frequency. The vibration of the cantilevered reed induces resonance between the liquid and the cantilevered reed and the resonance results in an ultrasound wave within the liquid. Upon the introduction of a gas into the liquid within the mixing chamber, wherein the gas is introduced proximate to the liquid outlet of the convergent nozzle, the mixing of the gas into the liquid is effected by the ultrasound wave generated by the cantilevered reed.

In operation of the system of the present invention, with an external liquid pump connected to the fluid channel 120 of the convergent nozzle 165, a liquid is introduced at the liquid inlet 160 of the convergent nozzle 165 and the pressure generated by the pump causes the liquid to pass through the liquid outlet 110 of the convergent nozzle, generating a high-pressure, high-speed jet resembling a liquid sheet. As the jet collides with the cantilevered reed 100, the reed 100 and the liquid begin to vibrate at certain frequencies. When the liquid vibrates at a frequency at or near the intrinsic frequency (Eigen frequency) of the reed 100, resonance occurs between the cantilevered reed 100 and the liquid, thus resulting in an ultrasound wave within the liquid having an intensity as high as 170-180 dB. Cavitation of the liquid is initiated by the ultrasound wave and as the liquid passes through the gas inducers 130 at a high rate of speed, a negative pressure results within the area of the gas inducers 130. Under these conditions, the gas is released into the liquid through the gas inducers 130 at a point of reduced pressure, resulting in the introduction of the gas into the liquid at a relatively slow and uniform rate. Following the introduction of the gas into the liquid within the mixing chamber 170, the gas and the liquid are allowed to circulate to facilitate the mixing of the gas and the liquid. Depending upon the particular specifications, the circulation time can range from a few minutes to less than one hour. During the mixing time, the gas and the liquid can uniformly and gradually penetrate into each other. The shock wave resulting from the cavitation of the liquid enables continuous mixing of the liquid and the gas, with the cavitation gas bubbles continuously being broken until a stable size of the gas bubbles is established and the gas is uniformly distributed in the liquid. The resulting gas bubbles may be micron or nano-scale in size.

The method of the present invention enables the efficient generation of a homogenous liquid-gas mixture. In a particular embodiment, the gas is hydrogen and the liquid is water and the method generates a homogenized hydrogen-water mixture, wherein the gas is physically added to the water and is not created by a chemical reaction in the liquid.

The present invention provides an improved fluid dynamic based ultrasound mixing system and method for mixing a liquid and a gas that is efficient, economical and capable of generating a homogenous liquid-gas mixture. In particular, a fluid dynamic based ultrasonic jet homogenizer for generating a hydrogen-water mixture is provided.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain the principles and practical applications, to thereby enable others skilled in the art to best utilize the various embodiments with various modifications as are suited to the particular use contemplated. It is intended that the scope be defined by the claims appended hereto and their equivalents.

1. A system for mixing a gas and a liquid, the system comprising:
a convergent nozzle, the convergent nozzle having a liquid inlet for receiving a liquid into a fluid channel of the nozzle and a liquid outlet for ejecting the liquid from the fluid channel of the convergent nozzle, wherein the liquid is ejected from the liquid outlet at a predetermined outlet velocity;
a mixing chamber positioned to receive the liquid ejected from the liquid outlet of the convergent nozzle;
at least one gas introducer positioned within the mixing chamber and located proximate to the liquid outlet of the convergent nozzle, the at least one gas introducer to introduce a gas into the liquid; and
a cantilevered reed positioned within the mixing chamber, the cantilevered reed to vibrate at an intrinsic frequency when subjected to the liquid ejected from the liquid outlet at the predetermined output velocity, the vibration of the cantilevered reed to induce resonance between the liquid and the cantilevered reed, the resonance resulting in an ultrasound wave within the liquid for mixing the gas and the liquid.

2. The system of claim 1, wherein the gas is an inert gas.

3. The system of claim 1, wherein the gas is hydrogen.

4. The system of claim 1, wherein the liquid is water.

5. The system of claim 1, wherein mixing the gas and the liquid results in a homogenized liquid-gas mixture.

6. The system of claim 1, further comprising a housing and wherein the convergent nozzle, is secured within the housing.

7. The system of claim 1, further comprising a reed bracket and wherein the cantilevered reed is secured within the reed bracket by a securing device.

8. The system of claim 1, further comprising a pipe and wherein the system is positioned within the pipe.

9. The system of claim 1, wherein the liquid outlet of the convergent nozzle is a substantially narrow slit opening.

10. The system of claim 1, wherein the at least one gas introducer further comprises:
a gas inlet pipe for receiving the gas to be mixed with the liquid; and
a gas outlet pipe, coupled to the gas inlet pipe, for ejecting the gas into the mixing chamber, the gas outlet pipe positioned substantially perpendicular to a longitudinal axis of the cantilevered reed and the gas outlet pipe comprising a plurality of spaced apart apertures for ejecting the gas into the mixing chamber.

11. The system of claim 1, wherein the at least one gas introducer further comprises:
a first gas inlet pipe for receiving the gas to be mixed with the liquid;
a first gas outlet pipe, coupled to the first gas inlet pipe, the first gas outlet pipe for ejecting the gas into the mixing chamber, the first gas outlet pipe positioned on a first side of the cantilevered reed and substantially perpendicular to a longitudinal axis of the cantilevered reed and the first gas outlet pipe comprising a plurality of spaced apart apertures for ejecting the gas into the mixing chamber;
a second gas inlet pipe for receiving the gas to be mixed with the liquid; and
a second gas outlet pipe, coupled to the second gas inlet pipe, for ejecting the gas into the mixing chamber, the second gas outlet pipe positioned on a second side of the cantilevered reed and substantially perpendicular to the longitudinal axis of the cantilevered reed and the second gas outlet pipe comprising a plurality of spaced apart apertures for ejecting the gas into the mixing chamber.

12. The system of claim 7, wherein the cantilevered reed comprises:
a tapered reed tip located proximate to the liquid outlet of the convergent nozzle; and
a substantially planar body portion secured to reed bracket distal from the liquid outlet.

13. The system of claim 1, further comprising a liquid pump configured for introducing the liquid into the fluid channel of the convergent nozzle at the liquid inlet, wherein the pump introduces the liquid at a predetermined input velocity.

14. A system for mixing a gas into a liquid, the system comprising:
a convergent nozzle, the convergent nozzle having a liquid inlet for receiving a liquid into a fluid channel of the nozzle and a liquid outlet for ejecting the liquid from the fluid channel of the convergent nozzle, wherein the liquid is ejected from the liquid outlet at a predetermined outlet velocity;
a mixing chamber positioned to receive the liquid ejected from the liquid outlet of the convergent nozzle;
a first gas introducer positioned within the mixing chamber, the first gas introducer located proximate to the liquid outlet of the convergent nozzle and positioned perpendicular to a direction of the flow of the liquid ejected from the liquid outlet, the first gas introducer to introduce a gas into the liquid;
a second gas introducer positioned within the mixing chamber, the second gas introducer located proximate to the liquid outlet of the convergent nozzle and positioned perpendicular to the direction of the flow of the liquid ejected from the liquid outlet and facing the first gas introducer, the second gas introducer to introduce a gas into the liquid; and
a cantilevered reed positioned within the mixing chamber, the cantilevered reed to vibrate at an intrinsic frequency when subjected to the liquid ejected from the liquid outlet at the predetermined output velocity, the vibration of the cantilevered reed to induce resonance between the liquid and the cantilevered reed, the resonance resulting in an ultrasound wave within the liquid for mixing the gas and the liquid.

15. A method for mixing a gas and a liquid, the method comprising:
receiving a liquid at a liquid inlet of a convergent nozzle;
ejecting the liquid at a predetermined output velocity from a liquid outlet of the convergent nozzle into a mixing chamber, the mixing chamber comprising a cantilevered reed positioned within the mixing chamber, the ejection of the liquid from the liquid outlet causing the cantilevered reed to vibrate at an intrinsic frequency, the vibration of the cantilevered reed to induce resonance between the liquid and the cantilevered reed the resonance resulting in an ultrasound wave within the liquid;
introducing a gas into the liquid within the mixing chamber, wherein the gas is introduced proximate to the liquid outlet of the convergent nozzle; and
mixing the gas into the liquid using the ultrasound wave generated by the cantilevered reed.

16. The method of claim 15, wherein the gas is an inert gas

17. The method of claim 15, wherein the gas is hydrogen.

18. The method of claim 15, wherein the liquid is water.

19. The method of claim 14, wherein receiving a liquid at a liquid inlet of a convergent nozzle further comprises, receiving the liquid from a liquid pump at a predetermined input velocity.

20. The method of claim 14, wherein mixing the gas into the liquid results in a homogenized liquid-gas mixture.
